(19) United States
(12) Patent Application Publication
(10) Pub. No.: US 2005/0163217 A1
(43) Pub. Date: Jul. 28, 2005

(54) Method and apparatus for coding and decoding video bitstream

(75) Inventors: Sung-chol Shin, Suwon-si (KR); Jong-won Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/041,370

(22) Filed: Jan. 25, 2005

(30) Foreign Application Priority Data
Jan. 27, 2004 (KR) 10-2004-0005024

(51) Int. Cl. H04N 7/12

(52) U.S. Cl. 375/240.12; 375/240.01

(57) ABSTRACT

Provided are a video encoder, a video coding method, a video decoder, and a video decoding method for transmitting a compressed video signal based on a suitable compression method adaptively selected according to the environment. The video coder includes a first encoding portion that removes temporal and spatial redundancy of input video frames, quantizes transform coefficients generated by removing temporal and spatial redundancies from the input video frames, and generates a bitstream, a second encoding portion that removes spatial and temporal redundancy of input video frames, quantizes transform coefficients generated by removing spatial and temporal redundancies from the input video frames, and generates a bitstream, and a mode selector that compares the bitstreams input from the first encoding portion and the second encoding portion with each other, and outputs only the bitstream selected based on the comparison result. Therefore, video frames decoded with various resolution levels can be restored.

### CROSS-REFERENCE TO RELATED APPLICATION

This application claims priority from Korean Patent Application No. 10-2004-0005024 filed on Jan. 27, 2004 in the Korean Intellectual Property Office, the disclosure of which is incorporated herein by reference in its entirety.

### BACKGROUND OF THE INVENTION

1. Field of the Invention

The present invention relates to video compression, and more particularly, to a method and apparatus for coding and decoding a video stream in a more efficient manner adaptively to the environment.

2. Description of the Related Art

With the development of information communication technology, including the Internet, there have been increasing multimedia services containing various kinds of information such as text, video, audio and so on. Multimedia data requires a large capacity of storage media and a wide bandwidth for transmission since the amount of multimedia data is usually large. For example, a 24-bit true color image having a resolution of 640*480 needs a capacity of 640*480*24 bits, i.e., data of about 7.37 Mbits, per frame. When this image is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

A basic principle of data compression lies in removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and limited perception of high frequency.

FIG. 1 is a block diagram of a conventional MC-EZBC (Motion Compensated Embedded Zeroblock Coding) video encoder.

A temporal transform unit 110 removes temporal redundancy of an input video frame. The temporal transform unit 110 includes a motion estimation unit 112 and a temporal filtering unit 114.

The motion estimation unit 112 compares various blocks of a current frame that is being in motion estimation with blocks of referred frames corresponding to the blocks of the current frame, and obtains optimal motion vectors.

The temporal filtering unit 114 performs a temporal filtering using information on the reference frames and the motion vectors obtained by the motion estimation unit 112.

The frames from which the temporal redundancies have been removed by the temporal transform unit 110, i.e., temporally filtered frames, are transferred to a spatial transform unit 120 to remove spatial redundancy therefrom. A wavelet transform is used to remove spatial redundancy for satisfying spatial scalability requirements.

The temporally filtered frames are converted to transform coefficients by spatial transform. The transform coefficients are then delivered to a quantizer 130 for quantization. The quantizer 130 quantizes the real-number transform coefficients with integer-valued coefficients. In other words, the quantization can reduce the quantity of bits required to express image data. In addition, by performing embedded quantization on transform coefficients, it is possible to achieve signal-to-noise ratio (SNR) scalability.

A bitstream generator 140 generates a bitstream with a header, containing coded image data, the motion vectors, and other information including reference frame numbers.

Meanwhile, in a case where a wavelet transform is used to remove spatial redundancy, an original image still remains in a wavelet-transformed frame. Accordingly, a temporal transform may be performed on a frame which is transformed first by the wavelet transform. This method is called a wavelet domain filtering method, or an in-band scalable video coding, as to be described in FIG. 2.

FIG. 2 is a block diagram of a video encoder functioning based on the in-band scalable video coding. Various blocks of the shown video encoder operate in the same manner as described in FIG. 1. A difference between the encoders in FIGS. 1 and 2 is in that the encoder shown in FIG. 2 performs a spatial transform, with the spatial transform unit 210, on an input frame, followed by performing a temporal transform on the spatially transformed frame via the temporal transform unit 220.

The above-described video coding methods are different from each other from video compression efficiency or restoration performance in decoding a compressed video. For example, like the encoder shown in FIG. 1, in the case of using a spatial domain temporal filtering method in which removing of spatial redundancy is preceded by removing of temporal redundancy, which will be referred to as a first encoding mode, each coded frame is compressed using a motion vector obtained for a single resolution. When a coded video is decoded with a variety of resolution levels, decoding is performed using the motion vector obtained for a single resolution. Thus, a precision level of a video restored based on the single resolution deteriorates. In particular, when a video is restored into a low resolution video using the motion vector of a frame coded with a high resolution level, simply scaling a motion vector unavoidably lowers decoding accuracy of a frame.

Meanwhile, like the encoder shown in FIG. 2, in a case of using a wavelet domain temporal filtering method in which removing of temporal redundancy is preceded by removing of spatial redundancy, which will be referred to as a second encoding mode, multiple motion vectors for various resolution levels are obtained because a spatial transform is first performed. In this case, since a motion vector suitable for a resolution level required for decoding can be selected from the multiple motion vectors, the decoding precision can be increased. In a case where a frame should be decoded with high resolution, the first encoding mode is more advantageously used than the second encoding mode.

Therefore, a coding technique adaptively employing a more efficient compression method would be desirable.

### SUMMARY OF THE INVENTION

The present invention provides a video encoder, a video coding method, a video decoder, and a video decoding method, for transmitting a compressed video signal based on a suitable compression method adaptively selected according to the environment.

According to an aspect of the present invention, there is provided a video encoder, comprising a first encoding portion that removes temporal redundancy of input video frames, removes spatial redundancy of the input video frames, quantizes transform coefficients generated by removing temporal and spatial redundancies from the input video frames, and generates a bitstream, a second encoding portion that removes spatial redundancy of input video frames, removes temporal redundancy of the input video frames, quantizes transform coefficients generated by removing spatial and temporal redundancies from the input video frames, and generates a bitstream, and a mode selector that compares the bitstreams input from the first encoding portion and the second encoding portion with each other, and outputs only the bitstream selected based on the comparison result.

The mode selector may select and output the bitstream having a smaller quantity of data.

In addition, the mode selector may select and output a bitstream coded by the first encoding mode when a resolution level of a video to be restored is higher than or equal to a predetermined value, or a bitstream coded by the second encoding mode when a resolution level of a video to be restored is lower than the predetermined value.

Further, the mode selector may select and output a bitstream coded by an encoding portion selected by a user.

The bitstream output from the mode selector may include information on an order of removing spatial and temporal redundancies.

According to another aspect of the present invention, there is provided a video coding method comprising a first encoding operation of removing temporal redundancy of input video frames, removing spatial redundancy of the input video frames, quantizing transform coefficients generated by removing temporal and spatial redundancies from the input video frames, and generating a bitstream, a second encoding operation of removing spatial redundancy of input video frames, removing temporal redundancy of the input video frames, quantizing transform coefficients generated by removing spatial and temporal redundancies from the input video frames, and generating a bitstream, and comparing the bitstreams input from the first encoding portion and the second encoding portion with each other, and outputting only the bitstream selected based on the comparison result.

The selected bitstream may have a smaller quantity of data than the non-selected bitstream.

The selected bitstream may be a bitstream generated in the first coding operation when a resolution level of a video to be restored is higher than or equal to a predetermined value, or a bitstream generated in the second coding operation when a resolution level of a video to be restored is lower than the predetermined value.

The bitstream may be arbitrarily selected by a user.

The output bitstream may include information on an order of removing spatial and temporal redundancies.

According to still another aspect of the present invention, there is provided a video decoder comprising a bitstream interpreter interpreting an input bitstream to extract information on coded frames, a first decoding portion inversely quantizing information on the coded frames to generate transform coefficients, performing an inversely spatial transform on the transform coefficients, and performing an inverse temporal transform on the spatially transformed coefficients, and a second decoding portion inversely quantizing information on the coded frames to generate transform coefficients, performing an inversely temporal transform on the transform coefficients, and performing an inverse spatial transform unit on the temporally transformed coefficients.

Preferably, the bitstream interpreter extracts information on a redundancy removing order from the input bitstream and outputs information on the coded frames to the first or second decoding portion in the extracted redundancy removing order.

According to a further aspect of the present invention, there is provided a video decoding method comprising interpreting an input bitstream to extract information on coded frames, interpreting the information on a redundancy removing order from the extracted information to determine a decoding mode, and performing a decoding operation on the coded frames in the determined decoding mode.

The decoding mode may be implemented such that the information on the coded frames is inversely quantized to generate transform coefficients, an inversely spatial transform is performed on the transform coefficients, and an inverse temporal transform is performed on the spatially transformed coefficients, or that the information on the coded frames is inversely quantized to generate transform coefficients, an inversely temporal transform is performed on the transform coefficients, and an inverse spatial transform unit is performed on the temporally transformed coefficients.

### BRIEF DESCRIPTION OF THE DRAWINGS

The above and other aspects of the present invention will become more apparent by describing in detail exemplary embodiments thereof with reference to the attached drawings in which:

FIG. 1 is a schematic block diagram of a conventional Motion Compensated Embedded Zeroblock Coding (MC-EZBC) based video encoder;

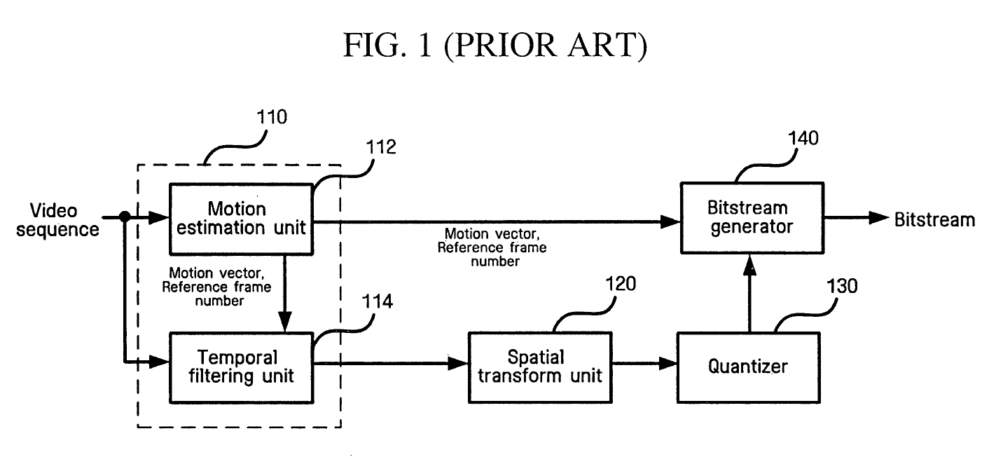

FIG. 2 is a block diagram of an in-band scalable video encoder;

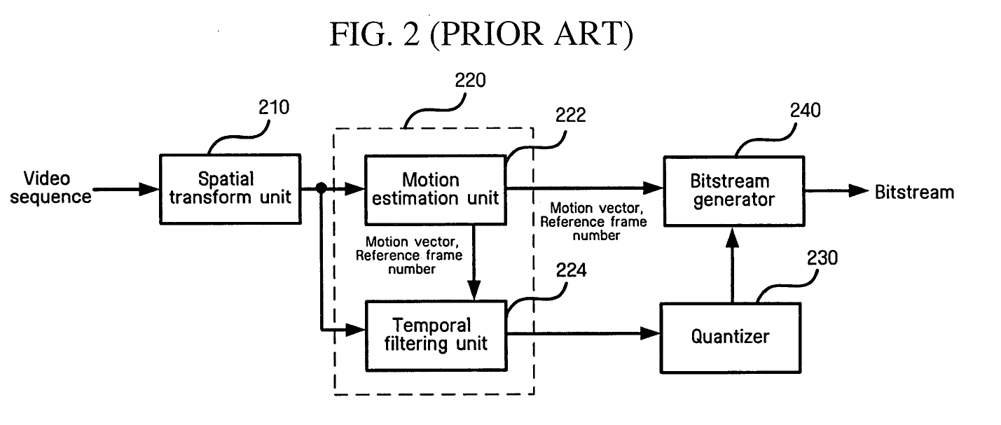

FIG. 3 is a block diagram of a video encoder according to an exemplary embodiment of the present invention;

FIG. 4 is a block diagram of a video encoder according to another exemplary embodiment of the present invention;

FIG. 5 is a flow chart showing a video coding method according to an exemplary embodiment of the present invention;

FIG. 6 is a block diagram showing a video decoder according to an exemplary embodiment of the present invention; and

FIG. 7 is a flow chart showing a video decoding method according to an exemplary embodiment of the present invention.

### DETAILED DESCRIPTION OF EXEMPLARY EMBODIMENTS OF THE INVENTION

A video encoder, a video coding method, a video decoder, and a video decoding method according to the present invention will now be described in detail with reference to the accompanying drawings.

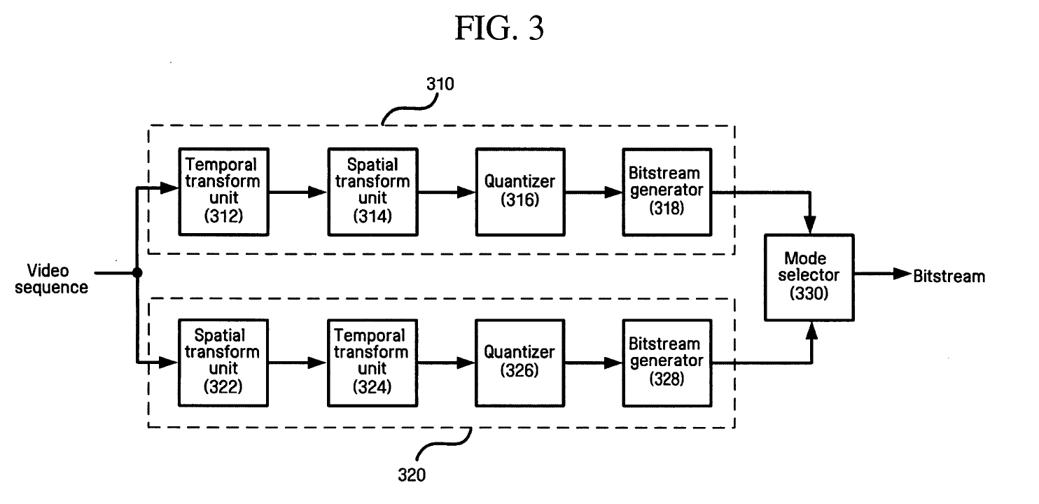

FIG. 3 is a schematic block diagram of a video encoder according to an exemplary embodiment of the present invention.

Referring to FIG. 3, the video encoder according to an exemplary embodiment of the present invention includes a first encoding portion 310 encoding a video frame by the first encoding mode, a second encoding portion 320 encoding a video frame by the second encoding mode, and a mode selector 330.

The first encoding portion 310 includes a temporal transform unit 312, which removes temporal redundancy of input video frames, a spatial transform unit 314, which removes spatial redundancy of the input video frames, a quantizer 316, which quantizes transform coefficients generated by removing temporal and spatial redundancies from the input video frames, and a bitstream generator 318, which generates a bitstream including quantized transform coefficients, motion vectors used in temporal filtering and reference frame numbers.

The temporal transform unit 312 includes a motion estimation unit (not shown) and a temporal filtering unit (not shown) to perform temporal filtering by compensating an interframe motion.

The higher a degree of similarity between a frame, which is a reference in temporally filtering an input frame, hereinafter referred to as a reference frame, and a current frame that is currently being temporally filtered, the higher a compression rate of the frame. Therefore, in order to perform optimal removal of temporal redundancy on each input frame, the current frame that is currently being temporally filtered is compared with a plurality of frames, and a frame having the highest degree of similarity is selected as a reference frame for removal of temporal redundancy. Hereinafter, candidate frames to be selected as a reference frame are referred to as referred frames.

The motion estimation unit compares various macroblocks of the current frame that is currently being temporally filtered with macroblocks of the referred frames corresponding to the macroblocks of the current frame to obtain optimal motion vectors.

The temporal filtering unit performs a temporal transform using information on the reference frames and the motion vectors obtained by the motion estimation unit. The referred frames from which the corresponding motion vectors are obtained are used as reference frames for removing temporal redundancy from the current frame.

Frames from which temporal redundancy has been removed, that is, temporally filtered frames, are transferred to the spatial transform unit 314 for removal of spatial redundancy. One method of removing spatial redundancy that can satisfy spatial scalability is a wavelet transform, although the present invention is not limited to this method.

In a known wavelet transform technique, a frame is decomposed into four portions. A quarter-sized image (L image) that is similar to the entire image is placed in the upper left portion of the frame while information (H image) needed to reconstruct the entire image from the L image is placed in the other three portions. In the same way, the L image may be decomposed into a quarter-sized LL image and information needed to reconstruct the L image. Image compression using the wavelet transform is applied to the JPEG 2000 standard, and removes spatial redundancies between frames. Furthermore, the wavelet transform enables the original image information to be stored in the transformed image that is a reduced version of the original image, in contrast to a Discrete Cosine Transform (DCT) method, thereby allowing video coding that provides spatial scalability using the reduced image.

The temporally filtered frames are converted into transform coefficients after being subjected to spatial transform, which are then transferred to the quantizer 316 for quantization. The quantizer 316 quantizes real-number transform coefficients with integer-valued coefficients. In other words, the quantization can reduce the quantity of bits required to express image data.

Since temporal filtering has been usually performed prior to spatial transform in conventional video compression, the term “transform coefficient” has been predominantly used to indicate a value generated through spatial transform. In other words, a transform coefficient is referred to as a DCT coefficient when it is generated through DCT or is referred to as a wavelet coefficient when it is generated through a wavelet transform. In the present invention, the transform coefficient is intended to mean a value obtained by removing spatial redundancy and temporal redundancy from frames before being subjected to quantization (i.e., embedded quantization).

By performing the embedded quantization on transform coefficients, it is possible to achieve signal-to-noise ratio (SNR) scalability while reducing the quantity of bits required for representing image data. In addition, the term “embedded quantization” is used to mean that a coded bitstream contains quantization information. In other words, compressed data is tagged by visual importance. Currently known embedded quantization algorithms include Embedded Zerotrees Wavelet Algorithm (EZW), Set Partitioning in Hierarchical Trees (SPIHT), Embedded ZeroBlock Coding (EZBC), Embedded Block Coding with Optimized Truncation (EBCOT), and so on. The present invention contemplates employing any known embedded quantization algorithm.

A bitstream generator 318 generates a bitstream with a header attached to data containing information generated after quantization, motion vectors, and reference frame numbers.

The second encoding portion 320 includes a spatial transform unit 322 removing spatial redundancy, a temporal transform unit 324 removing temporal redundancy, a quantizer 326 quantizing transform coefficients generated after removing spatial and temporal redundancies, and a bitstream generator 328 generating a bitstream including quantized transform coefficients, motion vectors used in temporal filtering and reference frame numbers.

The spatial transform unit 322 removes spatial redundancy of a plurality of frames constituting a video sequence. In this exemplary embodiment, the spatial transform unit 322 removes spatial redundancies of the frames using a wavelet transform. Frames from which temporal redundancy has been removed, that is, temporally filtered frames, are transferred to the temporal transform unit 324 for removal of temporal redundancy.

The temporal transform unit 324 removes temporal redundancies of the spatially transformed frames. To this end, the temporal transform unit 324 includes a motion estimation unit (not shown) and a temporal filtering unit (not shown). The temporal transform unit 324 operates in the same manner as the temporal transform unit 312 of the first encoding portion 310, except that input frames are frames that have been spatially transformed.

The quantizer 326 creates quantized image information, that is, coded image information, by quantizing the transform coefficients generated after spatial and temporal transforms, and transfers the created information to the bitstream generator 328.

The bitstream generator 328 generates a bitstream with a header attached to data including coded image information and motion vector information.

The first encoding portion 310 and the second encoding portion 320 can encode a video signal so as to satisfy temporal, spatial or SNR scalability.

The respective bitstream generators 318 and 328 may have a bitstream including order (priority) information in removing temporal and spatial redundancy, which will be simply referred to as a redundancy removal order, allowing a decoder unit to identify whether a video sequence is coded based on the first encoding mode or the second encoding mode. Including the order information in a bitstream may be performed in various modes.

For example, in a case where coding is performed based on the first encoding mode, the bitstream generated in the second encoding part 320 is made to include information on the redundancy removal order while the bitstream generated in the first encoding part 310 does not include information on the removal redundancy order. Meanwhile, the information on the redundancy removal order may be included in either case where the first encoding mode or the second encoding mode is selected.

A mode selector 330 receives bitstreams of video signals coded by the first and second encoding portions 310 and 320, and selects a more efficient bitstream among the received bitstreams according to the environment to output the same.

For example, in a case where the environment of a network established between an encoder and a decoder is taken into consideration, the mode selector 330 compares the quantities of bitstreams finally output after coding video sequences of a predetermined quantity of data by the first encoding portion 310 and the second encoding portion 320. If the network established between an encoder and a decoder is not in a good environment, an encoding part which generates a smaller quantity of bitstreams is selected by the mode selector 330 based on the comparison result to allow bitstreams generated by the selected encoder to be output to the decoder, thereby increasing a data transmission efficiency.

Alternatively, the mode selector 330 may select a video coding method according to a resolution required by a decoder side. In general, scalable video coding based on the first encoding mode exhibits high performance in case of restoring a high resolution video, while scalable video coding based on the second encoding mode exhibits high performance in case of restoring a low resolution video.

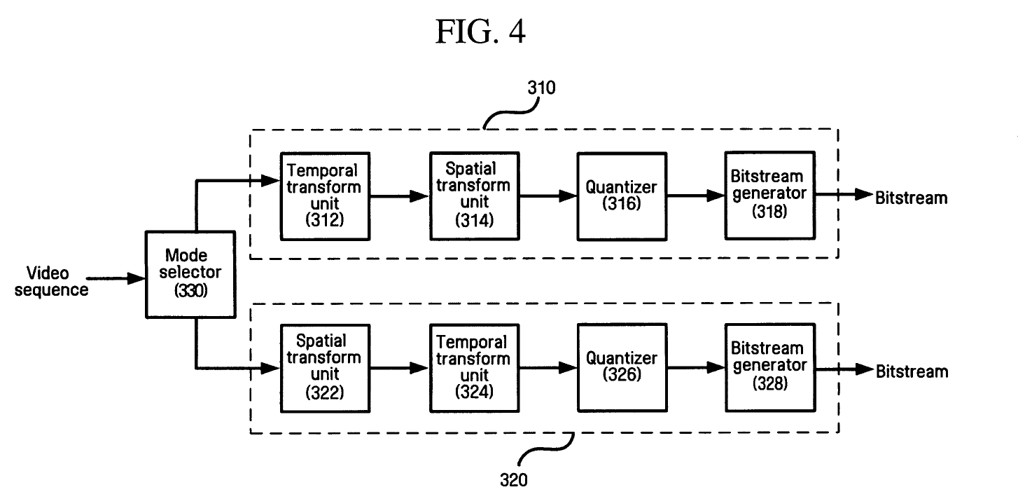

Thus, the mode selector 330 adaptively selects and outputs a bitstream coded by the first encoding mode when the decoder side needs to restore a video with a resolution level higher than a predetermined value, or a bitstream coded by the second encoding mode when the decoder side needs to restore a video with a resolution level lower than the predetermined value. In this case, as shown in FIG. 4, the mode selector 330, which is disposed ahead of the encoding portions 310 and 320, selects a more efficient encoding portion depending on the resolution level required by the decoder side, so that a video sequence may be input only to the corresponding encoding portion.

In addition, selection of an encoding portion that is to generate finally output bitstreams may depend on a user's selection.

The video encoders according to the exemplary embodiments shown in FIGS. 3 and 4 may be implemented not only in a hardware module but also in a software module and a computing apparatus capable of executing the software module.

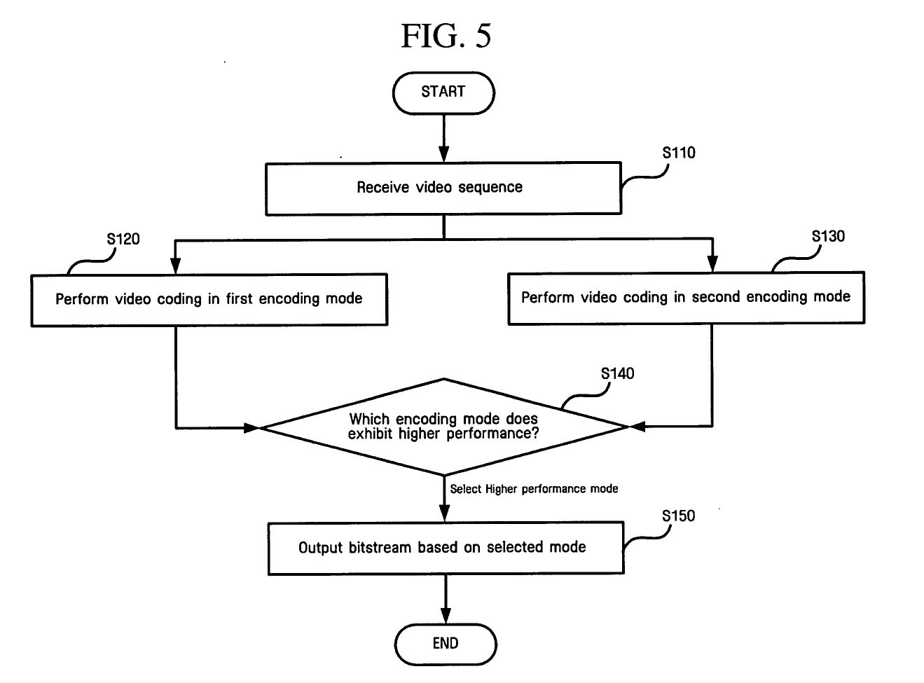

FIG. 5 is a flow chart showing a video coding method according to an exemplary embodiment of the present invention.

When a first video sequence is input in operation S110, each of the respective encoding portions 310 and 320 performs a video coding operation according to the first encoding mode in operation S120 and the second encoding mode in operation S130. Bitstreams based on the respective coding results are output to the mode selector 330. Then, the mode selector 330 compares the bitstreams resulting from coding based on both the modes with each other and selects a more efficient mode of the two modes in operation S140.

For example, for a given quantity of video sequences, the quantity of bitstreams output from the first encoding portion 310 are compared with that of bitstreams output from the second encoding portion 320 and an encoding portion which generates a smaller quantity of bitstreams can be selected to be used in a coding operation. Such an adaptive selection of an encoding portion can increase a utilization efficiency of transmission bandwidths of data when a network environment between an encoder side and a decoder side is poor.

In general, scalable video coding based on the first encoding mode exhibits high performance in case of restoring a high resolution video, while scalable video coding based on the second encoding mode exhibits high performance in case of restoring a low resolution video. Thus, in order to transmit bitstreams adaptively to the required resolution level, the first encoding mode is selected when a user requires a resolution level higher than a predetermined value, or the second encoding mode is selected when the user requires a resolution level lower than the predetermined value.

In this case, as shown in FIG. 4, the mode selector 330, which is disposed ahead of the encoding portions 310 and 320, selects a more efficient encoding portion depending on the resolution level required by the decoder side, so that a video sequence may be input only to the corresponding encoding portion.

When the more efficient video coding mode is selected according to the environment in the above-described manner, the mode selector 330 outputs only bitstreams based on the selected video coding mode in operation S150.

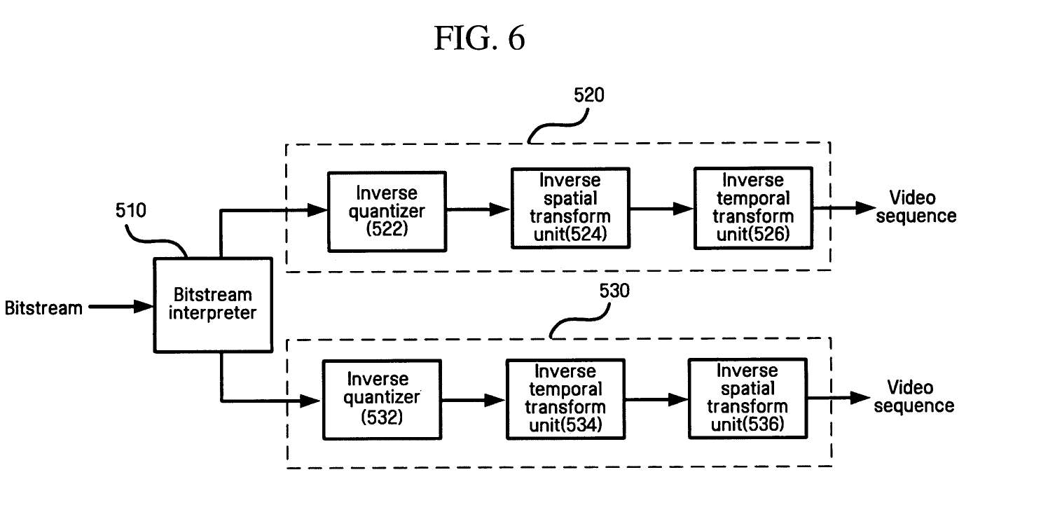

FIG. 6 is a block diagram showing a scalable video decoder according to an exemplary embodiment of the present invention.

The scalable video decoder includes a bitstream interpreter 510 interpreting an input bitstream to extract information on coded images (coded frames), a first decoding portion 520 restoring an image coded in the first encoding mode, and a second decoding portion 530 restoring an image coded in the second encoding mode.

First, the bitstream interpreter 510 interprets an input bitstream to extract information on coded images (coded frames), and determines a redundancy removing order. When the turn of the first decoding portion 520 comes round, the input bitstream is output to the first decoding portion 520. Otherwise, when the turn of the second decoding portion 530 comes round, the input bitstream is output to the second decoding portion 530.

Information on the coded frames input to the first decoding portion 520 is inversely quantized and converted into transform coefficients by an inverse quantizer 522. The transform coefficients are subjected to an inversely spatial transform by an inverse spatial transform unit 524. The inversely spatial transform is associated with spatial transformation of coded frames. When a wavelet transform is used in performing a spatial transform, the inversely spatial transform is performed using an inverse-wavelet transform. When a DCT transform is used in performing spatial transformation of coded frames, the inversely spatial transform is performed using an inverse DCT transform. The frames resulting after performing the inversely spatial transform are inversely temporally transformed by an inverse temporal transform unit 526 to then be restored into frames forming a video sequence.

Information on the coded frames input to the second decoding portion 530 is inversely quantized and converted into transform coefficients by an inverse quantizer 532. The transform coefficients are subjected to an inversely temporal transform by an inverse temporal transform unit 534. The coded frames resulting after performing the inversely temporal transform are inversely spatially transformed by an inverse spatial transform unit 536 to then be restored into frames forming a video sequence.

The inverse spatial transform performed by the inverse spatial transform unit 536 is based on an inverse wavelet transform technique.

The video decoder shown in FIG. 6 can be may be implemented not only in a hardware module but also in a software module.

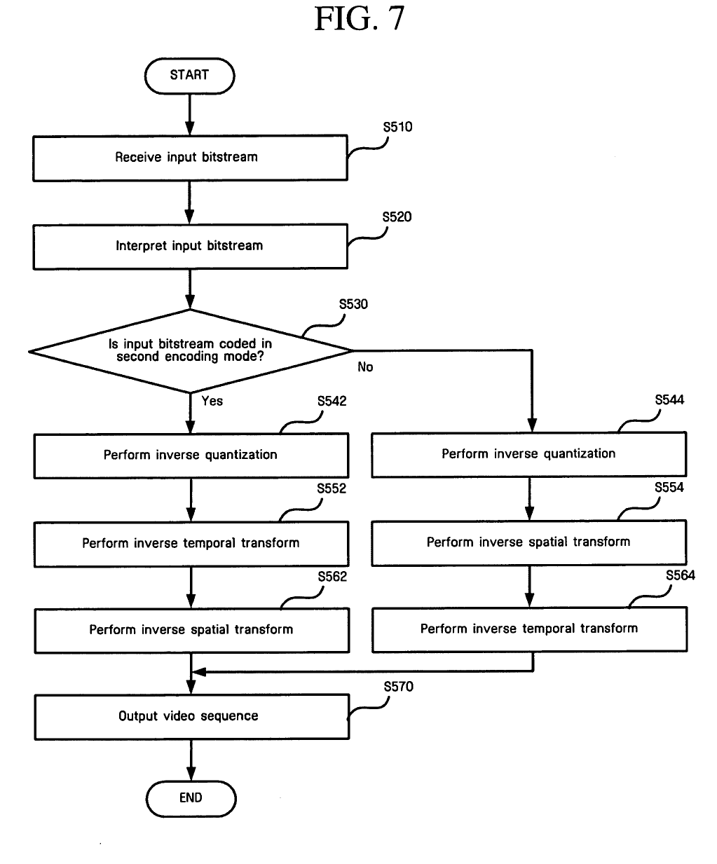

FIG. 7 is a flow chart showing a video decoding method according to an exemplary embodiment of the present invention.

When a first bitstream is input in operation S510, the bitstream interpreter 510 interprets the input bitstream to extract information on images, motion vectors, reference frame numbers, and a redundancy removing order in operation S520.

Restoration of a video sequence is performed in the redundancy removing order for the extracted information on images. Prior to the restoration, the redundancy removing order of the input bitstream is determined in operation S530. On the one hand, if the input bitstream has been encoded in the first encoding mode, the video restoration is performed through inverse quantization (operation S544), an inverse spatial transform (operation S554) and an inverse temporal transform (operation S564) in that order. On the other hand, if the input bitstream has been encoded in the second encoding mode, the restoration is performed through inverse quantization (operation S542), an inverse temporal transform (operation S552) and an inverse spatial transform (operation S562) in that order. Thereafter, the video sequence restored through the operations is finally output in operation S570.

In concluding the detailed description, those skilled in the art will appreciate that many variations and modifications can be made to the exemplary embodiments without substantially departing from the principles of the present invention. Therefore, the disclosed exemplary embodiments of the invention are used in a generic and descriptive sense only and not for purposes of limitation.

As described above, according to the present invention, one among a plurality of video coding modes can be adaptively selected to transmit a video signal compressed in the selected video coding mode, thereby decoding a coded video signal with a high efficiency according to the environment.

1. A video encoder, comprising:
a first encoding portion which removes temporal redundancy of input video frames, removes spatial redundancy of the input video frames, quantizes transform coefficients generated by removing temporal and spatial redundancies from the input video frames, and then generates a first bitstream;
a second encoding portion which removes spatial redundancy of the input video frames, removes temporal redundancy of the input video frames, quantizes transform coefficients generated by removing spatial and temporal redundancies from the input video frames, and then generates a second bitstream; and
a mode selector which selects one of the first bitstream and second bitstream.

2. The video encoder of claim 1, wherein the mode selector selects and outputs a bitstream having a smaller quantity of data.

3. The video encoder of claim 1, wherein the mode selector selects and outputs the first bitstream coded by the first encoding portion if a resolution level of a video to be restored is higher than or equal to a predetermined value, and the mode selector selects and outputs the second bitstream coded by the second encoding mode if a resolution level of a video to be restored is lower than the predetermined value.

4. The video encoder of claim 1, wherein the mode selector selects and outputs a bitstream coded by an encoding portion selected by a user.

5. The video encoder of claim 1, wherein the bitstream output from the mode selector includes information on an order of removing spatial and temporal redundancies.

6. The video encoder of claim 1, wherein said mode selector is positioned downstream of said first and second encoding portions and outputs a selected one of said first and second bit stream.

7. A video coding method comprising:
a first encoding operation of removing temporal redundancy of input video frames, removing spatial redundancy of the input video frames, quantizing transform coefficients generated by removing temporal and spatial redundancies from the input video frames, and then generating a first bitstream;
a second encoding operation of removing spatial redundancy of input video frames, removing temporal redundancy of the input video frames, quantizing transform coefficients generated by removing spatial and temporal redundancies from the input video frames, and then generating a second bitstream; and
selecting one of the first bitstream and second bitstream, and outputting the selected bitstream.

8. The video coding method of claim 7, wherein the selected bitstream has a smaller quantity of data than the non-selected bitstream.

9. The video coding method of claim 7, wherein the selected bitstream is a bitstream generated in the first coding operation if a resolution level of a video to be restored is higher than or equal to a predetermined value, or a bitstream generated in the second coding operation if a resolution level of a video to be restored is lower than the predetermined value.

10. The video coding method of claim 7, wherein the selected bitstream is a bitstream selected by a user.

11. The video coding method of claim 7, wherein the output bitstream includes information on an order of removing spatial and temporal redundancies.

12. The video coding method of claim 7, wherein said first and second encoding operations are performed simultaneously.

13. A recording medium having a computer readable program for executing the method of claim 7.

14. A video coding method comprising:
receiving a video sequence and selecting between a first available encoding operation and a second available encoding operation, and
if said first encoding operation is selected, removing temporal redundancy of input video frames of said video sequence, removing spatial redundancy of the input video frames, quantizing transform coefficients generated by removing temporal and spatial redundancies from the input video frames, and then generating a first bitstream; or
if said second encoding operation is selected, removing spatial redundancy of input video frames of said video sequence, removing temporal redundancy of the input video frames, quantizing transform coefficients generated by removing spatial and temporal redundancies from the input video frames, and then generating a second bitstream; and
outputting one of said first and second bitstreams.

15. The video coding method of claim 14, wherein the selected encoding operation produces a bitstream having a smaller quantity of data than the non-selected bitstream.

16. The video coding method of claim 14, wherein the first encoding operation is selected if a resolution level of a video to be restored is higher than or equal to a predetermined value, and the second encoding operation is selected if a resolution level of a video to be restored is lower than the predetermined value.

17. The video coding method of claim 14, wherein the selected encoding operation is selected by a user.

18. The video coding method of claim 14, wherein the output bitstream includes information on an order of removing spatial and temporal redundancies.

19. A recording medium having a computer readable program for executing the method of claim 14.

20. A video decoder comprising:
a bitstream interpreter which interprets an input bitstream to extract information on coded frames;
a first decoding portion which inversely quantizes information on the coded frames to generate first transform coefficients, performs an inversely spatial transform on the first transform coefficients, and performs an inverse temporal transform on the spatially transformed coefficients; and
a second decoding portion which inversely quantizes information on the coded frames to generate second transform coefficients, performs an inversely temporal transform on the second transform coefficients, and performs an inverse spatial transform unit on the temporally transformed coefficients.

21. The video decoder of claim 20, wherein the bitstream interpreter extracts information on a redundancy removing order from the input bitstream and outputs information on the coded frames to the first or second decoding portion in the extracted redundancy removing order.

22. The video decoder of claim 20, wherein the decoder outputs a video sequence from one of said first and second decoding portions.

23. A video decoding method comprising:
interpreting an input bitstream to extract information on coded frames;
interpreting the information on a redundancy removing order from the extracted information to determine a decoding mode; and
performing a decoding operation on the coded frames in the determined decoding mode.

24. The video decoding method of claim 23, wherein the decoding mode is implemented such that the information on the coded frames is inversely quantized to generate first transform coefficients, an inversely spatial transform is performed on the first transform coefficients, and an inverse temporal transform is performed on the spatially transformed coefficients, or that the information on the coded frames is inversely quantized to generate second transform coefficients, an inversely temporal transform is performed on the second transform coefficients, and an inverse spatial transform unit is performed on the temporally transformed coefficients.

25. A recording medium having a computer readable program for executing the method of claims 23.
